(19) United States
(12) Patent Application Publication
(10) Pub. No.: US 2013/0306908 A1
(43) Pub. Date: Nov. 21, 2013

(54) LIQUID-CRYSTALLINE COMPOUNDS AND LIQUID-CRYSTALLINE MEDIA

(71) Applicants: Axel Jansen, Darmstadt (DE); Matthias Bremer, Darmstadt (DE); Michael Wittek, Erzhausen (DE); Helmut Haensel, Muehltal (DE); Malgorzata Rillich, Darmstadt (DE); Julia Sprang, Weilrod (DE)

(72) Inventors: Axel Jansen, Darmstadt (DE); Matthias Bremer, Darmstadt (DE); Michael Wittek, Erzhausen (DE); Helmut Haensel, Muehltal (DE); Malgorzata Rillich, Darmstadt (DE); Julia Sprang, Weilrod (DE)

(73) Assignee: MERCK PATENT GMBH, Darmstadt (DE)

(21) Appl. No.: 13/981,704

(22) PCT Filed: Dec. 30, 2011
(86) PCT No.: PCT/EP11/06608

§ 371 Date: Jul. 25, 2013

(30) Foreign Application Priority Data
Jan. 25, 2011 (DE) 10 2011 009 338.9

(51) Int. Cl. C09K 19/34

(52) U.S. Cl. CPC C09K 19/3402
USPC 252/299.61; 549/374; 549/427

(57) ABSTRACT

The present invention relates to liquid-crystalline compounds containing an O-heterocyclic ring, three partially fluorinated benzene rings and a —CF₂O— bridge between the rings. In addition, the invention relates to liquid-crystalline media prepared therewith and to liquid-crystal display devices (LC displays) containing these media.

The present invention relates to liquid-crystalline compounds containing an O-heterocyclic ring, three partially fluorinated benzene rings and a —CF₂O— bridge between the rings. In addition, the invention relates to liquid-crystalline media prepared therewith and to liquid-crystal display devices (LC displays) containing these media.

Liquid-crystalline media have been used for some time in LC displays in order to display information. Compounds containing 4 or 5 rings, including an O-heterocyclic ring and a —CF₂O— bridge, have already been proposed for liquid-crystalline display devices, for example in the specifications EP 0 819 685 A1, JP 10-251186 A, EP 2 028 252 A1, WO 2004/048501 A1, US 2009/0237610 A1 and US 2009/0059157 A1. In addition, the specification US 2009/0059157 A1 discloses LC displays which operate in the optically isotropic blue phase, and a multiplicity of possible compounds as liquid-crystalline component. The compounds according to the invention specifically are not revealed by these disclosures.

Besides the displays with nematic liquid crystals which are well known to the person skilled in the art, applications based on media having a blue phase are also increasingly being developed. These are distinguished by particularly short response times. In display applications in which electro-optical effects of the liquid-crystalline blue phases are utilised, the parameters Δ∈ and Δn, in particular, are of crucial importance.

The basis for the fast switching operations in these phases is the so-called Kerr effect. The Kerr effect is the change in birefringence of an optically transparent and isotropic material caused by an external electric field. The change in birefringence is given by the following equation:

Δn_{induced}=λ·K·E²

where Δn_{induced} is the induced birefringence, K is the Kerr constant, and E is the applied electric field. λ represents the wavelength. Unusually high Kerr constants are observed for materials in the blue phase.

Kikuchi et al. describe the dependence of the Kerr constant on the LC material properties [H. Kikuchi et al., Appl. Phys. Lett. 2008, 92, 043119]. Accordingly, the Kerr constant is proportional to the product of birefringence and dielectric anisotropy of the liquid-crystalline medium:

K˜Δn·Δ∈

For fast switching processes and low switching voltages, materials having high values of the Kerr constant and thus high values of the product Δn·Δ∈ are required.

It is an object of the present invention to provide compounds having advantageous properties for use in liquid-crystalline media. In particular, they should be suitable for use in displays which use media having polymer-stabilised blue phases. Materials are required here which enable fast switching, have a good voltage holding ratio (VHR), require low voltages for the switching process (Vₒₚ), have high clearing points, exhibit low hysteresis, have a low memory effect and are stable to exposure to light and heat. In addition, the individual compounds should have adequate solubility in nematic LC media or themselves have a broad nematic phase range.

It is a further object of the invention to provide liquid-crystalline media which are essentially free from ester compounds or nitriles in order to increase the electrical resistance of the mixtures and the long-term stability thereof. The liquid-crystalline media known to date for operation in the optically isotropic blue phase sometimes comprise, for example, compounds of the formula

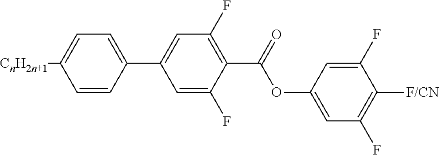

in which n=3-5,
some or all of which are to be replaced by compounds having similar physical properties and more pronounced stability.

These objects are achieved in accordance with the invention by compounds of the general formula I. Surprisingly, it has also been found that liquid-crystalline media having a suitable nematic phase range, high dielectric anisotropy Δ∈ and high Δn which do not have the disadvantages of the prior-art materials, or at least only do so to a considerably reduced extent, can be achieved with the compounds according to the invention. Substantially the same requirements are made of highly polar substances for purely nematic displays.

The invention encompasses compounds of the formula I,

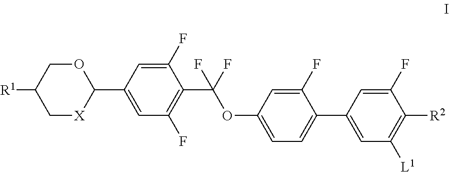

in which
L¹ denotes H or F, preferably F,
X denotes O or CH₂,
R¹ denotes an unsubstituted alkyl radical having 1 to 15 C atoms, where, in addition, one or more CH₂ groups in this radical may each be replaced, independently of one another, by —C≡C—, —CH═CH—, —CF═CF—, —CF═CH—, —CH═CF—, —(CO)O—, —O(CO)—, —(CO)— or —O— in such a way that O atoms are not linked directly to one another,
and
R² denotes F, CF₃ or OCF₃, preferably CF₃ or OCF₃.

The compounds according to the invention have a relatively high clearing point, extremely high dielectric anisotropy (Δ∈), high optical anisotropy (Δn) and low rotational viscosity. They have, alone or mixed with further mesogenic components, a nematic phase over a broad temperature range. These properties make them suitable for use in liquid-crystalline media, for example for displays of the TN-TFT, IPS, FFS, ‘blue-phase’, HT-VA, etc., type, characterised by media having positive dielectric anisotropy, which are familiar to the person skilled in the art. They are particularly suitable for use in media in the region of the blue phase.

The radical R¹ preferably denotes an alkyl radical having 1 to 15 C atoms, where, in addition, one or more CH₂ groups in this radical may each be replaced, independently of one another, by —C≡C—, —CH═CH—, —(CO)O—, —O(CO)—, —(CO)— or —O— in such a way that O atoms are not linked directly to one another. R¹ particularly preferably denotes an unsubstituted alkyl, alkenyl or alkoxy, in particular alkyl having 1 to 9 C atoms or alkenyl having 2 to 9 C atoms, and very particularly preferably a straight-chain alkyl having up to 9 C atoms.

The radical R² particularly preferably denotes CF₃. These compounds have a particularly high value of the product Δn·Δ∈.

Illustrative preferred embodiments of the invention are therefore, inter alia, the following structures:

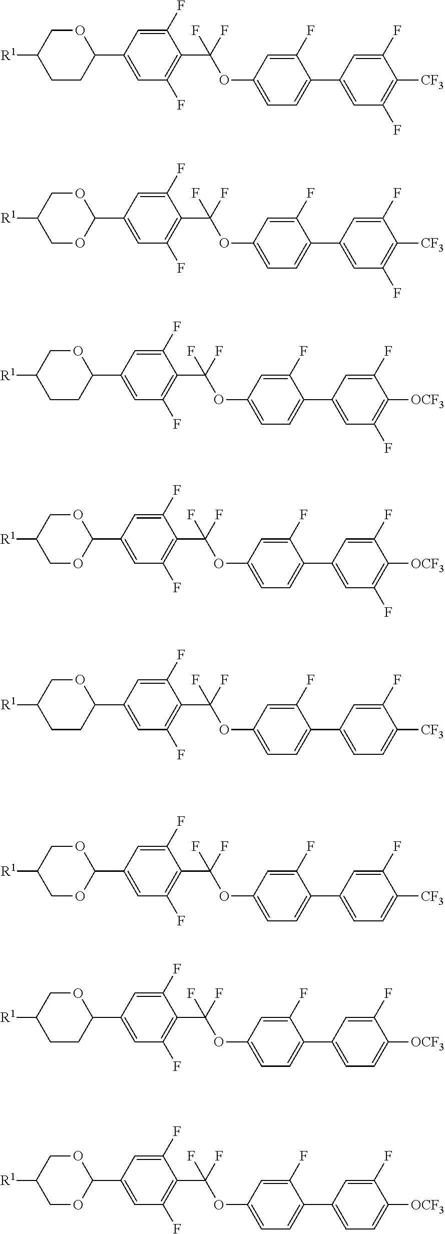

in which R¹ is as defined above, preferably a straight-chain alkyl group of the formula —CₙH₂ₙ₊₁, in which n=1, 2, 3, 4, 5, 6 or 7, in particular 3.

The compounds of the formula I can advantageously be prepared as evident from the following illustrative synthesis (Schemes 1-3):

The compounds I are advantageously prepared starting from the aldehydes 1 (Schemes 1 and 2).

If X=CH₂, i.e. if the compounds I are tetrahydropyrans, the synthesis is carried out by reaction of the aldehydes 1 with 3-propenyl alcohols 2. The compounds 3 are formed in a cyclisation in the manner of a Prins reaction. Reductive elimination, here by means of hydrogenation on palladium/carbon in the presence of triethylamine, gives the tetrahydropyrans 4 (=compounds I where X=—CH₂—).

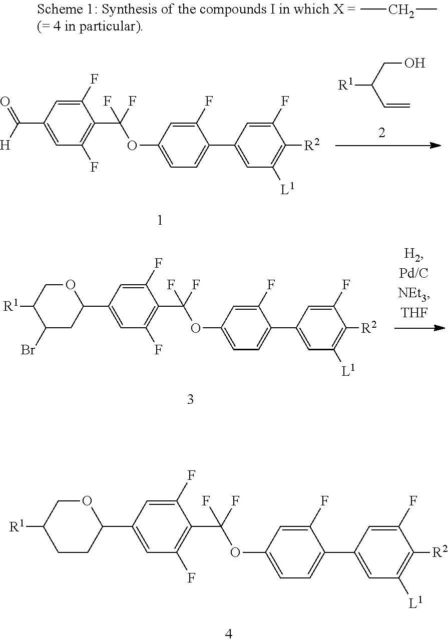

The reaction of the aldehyde with the homoallyl alcohol is carried out with the aid of a halogen-containing acid, preferably a halogen-containing Lewis acid, in an organic solvent, such as, for example, dichloromethane. A similar reaction of an aldehyde with an alkenol is described in J. O. Metzger et al. and the references cited therein (Bull. Soc. Chem. Belg. (1994), 103, 393-7).

The process can advantageously be carried out in the presence of a Lewis acid of the formula M(X¹)ₙ or R⁵M(X¹)ₙ₋₁, where
M denotes B, Al, In, Sn, Ti, Fe, Zn, Zr, Au or Bi;
X¹ denotes Cl, Br or I;
R⁵ denotes a straight-chain or branched alkyl radical having 1 to 10 carbon atoms; and
n is an integer 2, 3 or 4 and is selected so that it is equal to the formal oxidation number of M.

Examples of particularly suitable Lewis acids are halides of the elements boron, aluminium, iron, zinc or bismuth. Very particularly suitable are, for example, AlCl₃ or BiBr₃. Alternatively, Brönsted acids, such as hydrogen bromide (HBr), can also be employed instead of the Lewis acid.

The reductive elimination of the halogen from the resultant 4-halotetrahydropyrans can be carried out in various variants (cf. WO 2006/125526).

Dioxanes I (X=O) are obtained by reaction of the aldehydes 1 with 1,3-propanediols 5. This is typically carried out with acid catalysis.

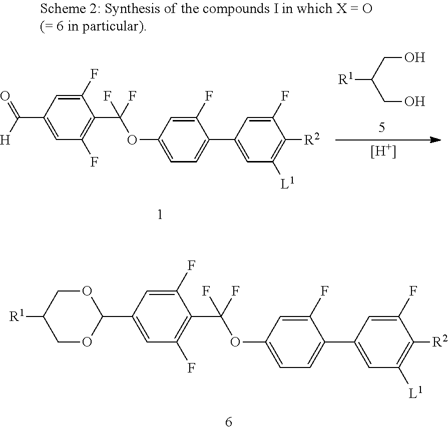

The acid added is preferably a sulfonic acid, particularly preferably p-toluenesulfonic acid or trifluoromethanesulfonic acid. In a preferred procedure, the water formed is removed from the reaction mixture by azeotropic distillation under the reaction conditions indicated. Preferred processes for the formation of dioxanes are likewise acetal formation variants catalysed by Lewis acids. Particular preference is also given to particularly mild processes with the aid of catalytic amounts of ruthenium halides or indium halides, in particular RuCl₃ and InCl₃ (cf. literature: B. C. Janu et al., Adv. Synth. Catal. (2004), 346, 446-50; J.-Y. Qi et al., Tetr. Lett. (2004), 45, 7719-21; S. K. De, R. A. Gibbs, Tetr. Lett. (2004), 45, 8141-4). The mild reaction conditions are particularly suitable for compounds containing moieties of the ether type and for acid-sensitive groups.

The starting materials required can be prepared analogously to processes known to the person skilled in the art and described in standard works of organic chemistry, such as, for example, in Houben-Weyl, Methoden der organischen Chemie [Methods of Organic Chemistry], Thieme-Verlag, Stuttgart.

The starting materials 1 are advantageously synthesised as shown in Scheme 3.

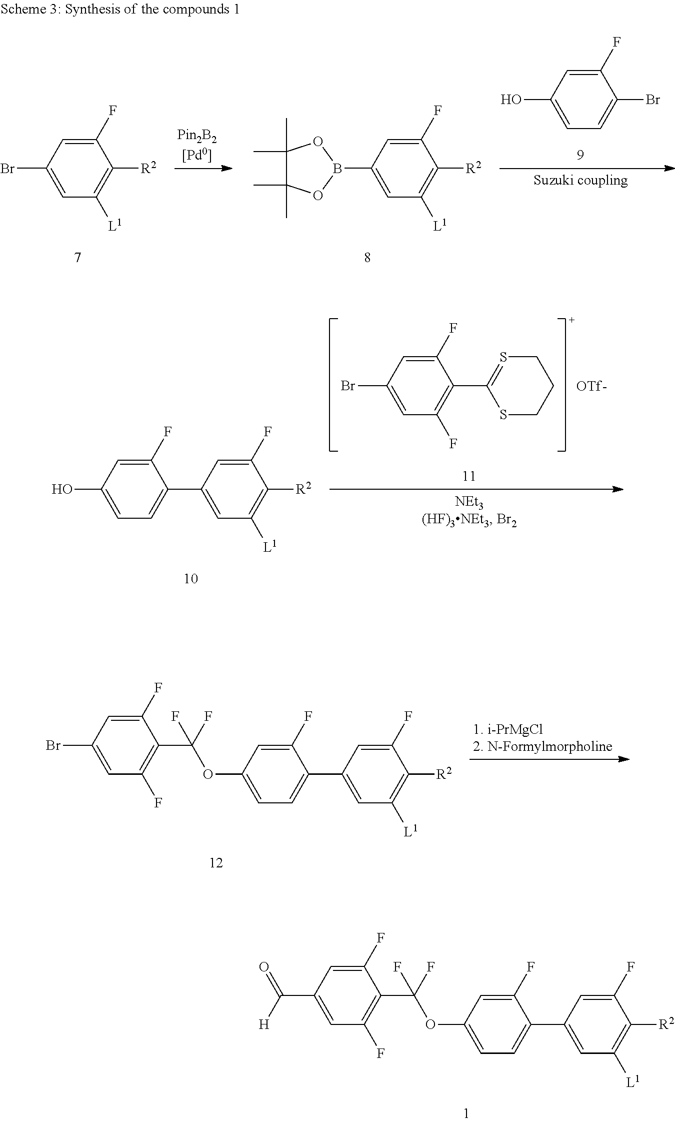

Firstly, the boronic acid esters 8 are prepared from the corresponding bromides 7. This is carried out by a palladium-promoted borylation using bis(pinacolato)diboron (Pin₂B₂). The compounds are then coupled to the para-bromophenols 9 (Suzuki coupling). The phenols 10 are reacted with the dithianylium salt 11 in the presence of base, and the respective adduct is subjected directly to oxidative desulfurisation [P. Kirsch, M. Bremer, A. Taugerbeck, T. Wallmichrath, Angew. Chem. Int. Ed. 2001, 40, 1480-1484]. This gives the compounds 12. Halogen-metal exchange, preferably using isopropylmagnesium chloride followed by reaction with a formylating reagent (for example formylmorpholine or DMF), gives the compounds 1.

The invention therefore also encompasses a process for the preparation of compounds of the formula I which comprises a reaction step in which an aldehyde of the formula A:

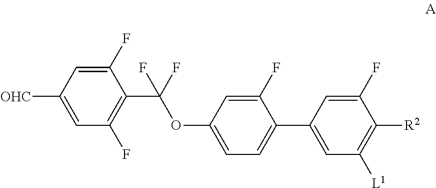

in which R² and L¹ are as defined for formula I,
is reacted with a compound of the formula B

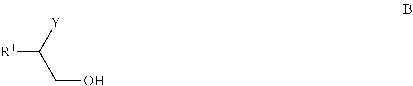

in which
in which R¹ is as defined for formula I, and
Y denotes a radical of the formula —CH═CH₂ (for tetrahydropyrans) or —CH₂—OH (for dioxanes),
under suitable reaction conditions.

Suitable methods for the preparation of compounds of the formula B in which Y denotes a radical of the formula —CH═CH and suitable reaction conditions for the preparation of tetrahydropyrans therefrom are disclosed, for example, in the specification WO 2006/125527 and are generally familiar to the person skilled in the art.

In a preferred embodiment, the process for the preparation of the compounds of the formula I therefore comprises a first reaction step which is characterised in that the compounds A and B are reacted in the presence of an acid.

The liquid-crystalline media in accordance with the present invention comprise one or more compounds of the formula I and optionally at least one further, preferably mesogenic compound. The liquid-crystalline media therefore preferably comprise two or more compounds. Preferred media comprise the preferred compounds of the formula I.

The liquid-crystalline media according to the invention preferably have positive dielectric anisotropy. They can be designed in such a way that they have very high dielectric anisotropy combined with high optical anisotropy.

Preferred further compounds for the liquid-crystalline media in accordance with the invention are selected from the compounds of the formulae II and III:

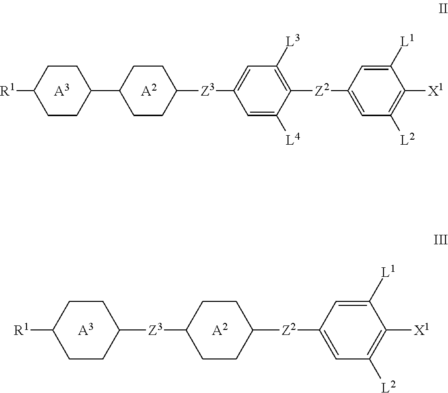

in which
R¹ in each case, independently of one another, denotes an unsubstituted alkyl radical having 1 to 15 C atoms, where, in addition, one or more CH₂ groups in this radical may each be replaced, independently of one another, by —C≡C—, —CH═CH—, —CF═CF—, —CF═CH—, —CH═CF—, —(CO)O—, —O(CO)—, —(CO)— or —O— in such a way that O atoms are not linked directly to one another, preferably a straight-chain alkyl radical having 2 to 7 C atoms,
A², A³, independently of one another, denote

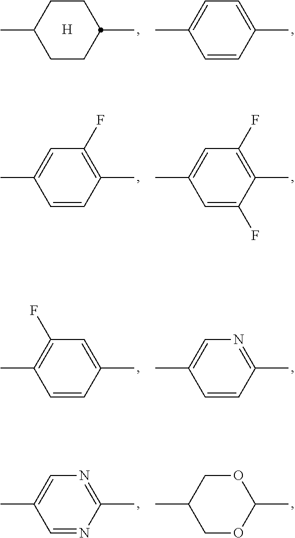

Z² Z³, independently of one another, denote a single bond, CF₂O, CH₂CH₂, CF₂CH₂, CF₂CF₂, CFHCFH, CFHCH₂, (CO)O, CH₂O, C≡C, CH═CH, CF═CH, CF═CF, where asymmetrical bonding units (for example CF₂O) may be oriented in both possible directions,
X¹ denotes F, Cl, CN, or
   alkyl, alkenyl, alkenyloxy, alkylalkoxy or alkoxy having 1 to 3 C atoms, which is mono- or polysubstituted by F, and
L¹ to L⁴ denote H or F.

The liquid-crystalline media preferably comprise between 10 and 50% by weight of compounds of the formula I. In the case of a total content of more than 10%, two or more compounds of the formula I with different chain lengths in the radical R¹ are preferably employed.

The liquid-crystalline media preferably comprise between 20 and 40% by weight of compounds of the formula II. The compounds of the formula III are preferably, if present, employed in amounts of up to 20% by weight. The remaining other compounds, if present, are selected from further compounds having high dielectric anisotropy, high optical anisotropy and preferably a high clearing point.

Liquid-crystalline media having disproportionately high dielectric anisotropies can be achieved through a high content of the compounds of the formula I, preferably supplemented by compounds of the formulae II and III.

Preferred compounds of the formula II are those of the formula IIa:

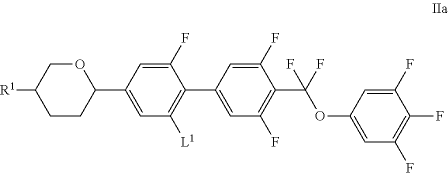

in which R¹ and L¹ are as defined for formula II.

Preferred compounds of the formula III are those of the formula IIIa or IIIb:

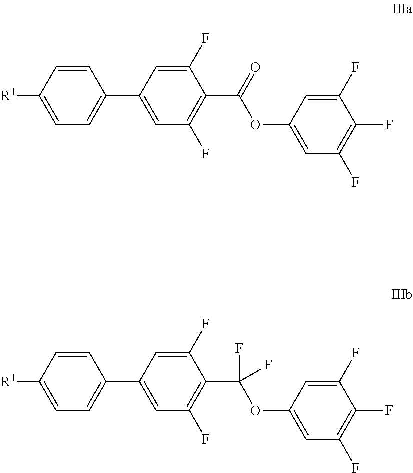

in which R¹ is as defined for formula III.

The invention furthermore relates to the use of the compounds of the formula I in liquid-crystalline media or in electro-optical displays, preferably in media and displays having an optically isotropic liquid-crystalline phase, preferably having a blue phase. This phase is preferably stabilised by a polymer, which is preferably formed in the liquid-crystalline medium by polymerisation of corresponding monomers. In general, the monomer content of the medium is polymerised at a temperature at which it is in the blue phase. The stability range of this phase is thus broadened. A considerable improvement in the hitherto achievable properties of the polymer-stabilised media in the blue phase is associated with the compounds and media according to the invention.

The liquid-crystalline media may in addition comprise further additives, such as stabilisers, chiral dopants and nanoparticles. The individual compounds added are employed in concentrations of preferably 0.1 to 6%. The concentrations of the individual compounds used are preferably in each case in the range from 0.1 to 3%. However, the concentration data for the other constituents of the liquid-crystal mixtures, i.e. the liquid-crystalline or mesogenic compounds and if appropriate the polymerisation components, are indicated without taking into account the concentration of these additives.

The liquid-crystalline media preferably comprise 0.01 to 10% by weight of an optically active, chiral dopant. This supports the formation of a liquid-crystalline blue phase. For blue phases, chiral dopants having a high HTP (‘helical twisting power’) are preferably employed, typically in the range 2-5% by weight.

The media according to the invention preferably comprise one or more polymerisable compounds (monomers) or are stabilised by a polymer obtained therefrom, where the polymerisation is preferably carried out in the blue phase.

The liquid-crystalline media preferably comprise 0 to 10% by weight, in particular 0.01 to 5% by weight and particularly preferably 0.1 to 3% by weight, of stabilisers. The media preferably comprise one or more stabilisers selected from 2,6-di-tert-butylphenols, 2,2,6,6-tetramethylpiperidines or 2-benzotriazol-2-ylphenols. These assistants are known to the person skilled in the art and are commercially available, for example as light stabilisers.

An embodiment of the invention is therefore also a process for the preparation of a liquid-crystal medium which is characterised in that one or more compounds of the formula I are mixed with one or more liquid-crystalline compounds, preferably selected from the formulae II and III, optionally with one or more further compounds and optionally with one or more additives. The polymerisable content of the liquid-crystalline medium is optionally subsequently polymerised.

The present invention furthermore relates to the use of the compounds or media according to the invention in an electro-optical device, preferably a liquid-crystal display, and to such devices themselves. The displays preferably operate at least partly in the region of the blue phase, which is preferably a polymer-stabilised blue phase. The media and displays alternatively also preferably operate in the nematic phase.

A polymer-stabilised device according to the invention is preferably produced by carrying out the polymerisation of the polymerisable constituents of the medium in the device itself, i.e. in the opto-electronic cell.

The structure of the electro-optical display device according to the invention preferably consists of a cell, which comprises two substrates opposite one another enclosing the liquid-crystalline medium, and electrodes installed in the cell. The electrodes are preferably designed in such a way that they are able to generate an electric field which has a component aligned parallel to the substrates (or perpendicular to the light axis) in the liquid-crystalline medium. The electrodes are preferably applied to one of the substrates as comb electrodes (interdigital electrodes). It is preferred for one or both substrates to be transparent. In the case of displays which operate in the blue phase, the optically isotropic medium becomes birefringent through the application of a voltage. An optical switching operation is achieved together with correspondingly arranged polarisers.

In the present application, the term dielectrically positive describes compounds or components where Δ∈>3.0, dielectrically neutral describes compounds or components where −1.5≦Δ∈≦3.0, and dielectrically negative describes compounds or components where Δ∈<−1.5. The dielectric anisotropy of the respective compound is determined from the results of a solution of 10% of the respective individual compound in a nematic host mixture. If the solubility of the respective compound in the host mixture is less than 10%, the concentration is reduced to 5%. The capacitance of the test mixtures is determined both in a cell with homeotropic alignment and also in a cell with homogeneous alignment. The cell thickness in the case of both cell types is about 20 μm. The applied voltage is a rectangular wave having a frequency of 1 kHz and an effective value of typically 0.5 V to 1.0 V, but is always selected so that it is below the capacitive threshold for the respective test mixture.

The host mixture used for dielectrically positive compounds is mixture ZLI-4792 and the host mixture used for dielectrically neutral and dielectrically negative compounds is mixture ZLI-3086, both from Merck KGaA, Germany. The absolute values of the dielectric constants of the compounds are determined from the change in the respective values of the host mixture on addition of the compounds of interest. The values are extrapolated to a concentration of the compounds of interest of 100%.

Components and liquid-crystalline media which have a nematic phase at the measurement temperature of 20° C. are measured as such, all others are treated like compounds.

The parameter ranges indicated in this application all include the limit values, unless expressly indicated otherwise.

Throughout the application, unless expressly indicated otherwise, the following conditions and definitions apply. All concentrations are indicated in percent by weight and in each case relate to the mixture as a whole. All temperatures, such as, for example, the melting point T(C,N) or T(C,S), the transition from the smectic phase (S) to the nematic phase (N) T(S,N) and the clearing point T(N,I), of the liquid crystals are indicated in degrees Celsius. All temperature differences are indicated in differential degrees. All physical properties which are typical of liquid crystals are, unless indicated otherwise, determined in accordance with “Merck Liquid Crystals, Physical Properties of Liquid Crystals”, status November 1997, Merck KGaA, Germany, and are shown for a temperature of 20° C. The optical anisotropy (Δn) is determined at a wavelength of 589.3 nm. Δ∈ is defined as (∈_{∥}-∈_{⊥}), while ∈ₐᵥₑ is (∈_{∥}+2 ∈_{⊥})/3.

The threshold voltages and all other electro-optical properties are determined using test cells produced at Merck KGaA, Germany. The test cells for the determination of Δ∈ have a cell thickness of about 20 μm. The electrode is a circular ITO electrode having an area of 1.13 cm² and a protective ring. The alignment layers are SE-1211 from Nissan Chemicals, Japan, for homeotropic alignment (∈_{∥}) and polyimide AL-1054 from Japan Synthetic Rubber, Japan, for homogeneous alignment (∈_{⊥}). The capacitances are determined using a Solatron 1260 frequency response analyser using a sine wave with a voltage of 0.3 Vᵣₘₛ. The light used in the electro-optical measurements is white light. A set-up with a commercially available DMS instrument from Autronic-Melchers, Germany, is used here. The characteristic voltages are determined with perpendicular observation. The threshold voltage (V₁₀), mid-grey voltage (V₅₀) and saturation voltage (V₉₀) are determined for a relative contrast of 10%, 50% and 90% respectively.

The values for the components of the properties perpendicular and parallel to the director of the liquid crystal are obtained by alignment of the liquid crystal in a magnetic field. For this purpose, the magnetic field of a permanent magnet is used. The strength of the magnetic field is 0.35 tesla. The alignment of the magnet is set correspondingly and then rotated correspondingly through 90°.

In the present application, unless expressly indicated otherwise, the term compounds denotes both one compound and also a plurality of compounds.

The term “alkyl” preferably encompasses straight-chain and branched alkyl groups having 1 to 15 carbon atoms, in particular the straight-chain groups methyl, ethyl, propyl, butyl, pentyl, hexyl and heptyl. Groups having 2 to 10 carbon atoms are generally preferred.

The term “alkenyl” preferably encompasses straight-chain and branched alkenyl groups having 2 to 15 carbon atoms, in particular the straight-chain groups. Particularly preferred alkenyl groups are C₂- to C₇-1 E-alkenyl, C₄- to C₇-3E-alkenyl, C₅- to C₇-4-alkenyl, C₆- to C₇-5-alkenyl and C₇-6-alkenyl, in particular C₂- to C₇-1 E-alkenyl, C₄- to C₇-3E-alkenyl and C₅- to C₇-4-alkenyl. Examples of further preferred alkenyl groups are vinyl, 1E-propenyl, 1E-butenyl, 1E-pentenyl, 1E-hexenyl, 1E-heptenyl, 3-butenyl, 3E-pentenyl, 3E-hexenyl, 3E-heptenyl, 4-pentenyl, 4Z-hexenyl, 4E-hexenyl, 4Z-heptenyl, 5-hexenyl, 6-heptenyl and the like. Groups having up to 5 carbon atoms are generally preferred.

The term “alkoxy” preferably encompasses straight-chain radicals of the formula CₙH₂ₙ₊₁—O—, in which n denotes 1 to 10. n is preferably 1 to 6. Preferred alkoxy groups are, for example, methoxy, ethoxy, n-propoxy, n-butoxy, n-pentoxy, n-hexoxy, n-heptoxy, n-octoxy, n-nonoxy, n-decoxy.

The term “oxaalkyl” or “alkoxyalkyl” preferably encompasses straight-chain radicals of the formula CₙH₂ₙ₊₁—O—(CH₂)ₘ, in which n and m each, independently of one another, denote 1 to 10. Preferably, n is 1 and m is 1 to 6.

The term “fluorinated alkyl radical” preferably encompasses mono- or polyfluorinated radicals. Perfluorinated radicals are included. Particular preference is given to CF₃, CH₂CF₃, CH₂CHF₂, CHF₂, CH₂F, CHFCF₃ and CF₂CHFCF₃.

The term “fluorinated alkoxy radical” preferably encompasses mono- or polyfluorinated radicals. Perfluorinated radicals are included. Particular preference is given to OCF₃.

The liquid-crystal media according to the invention consist of a plurality of compounds, preferably 3 to 30, more preferably 4 to 20 and very preferably 4 to 16 compounds. These compounds are mixed in a conventional manner. In general, the desired amount of the compound used in lesser amount is dissolved in the compound used in greater amount. If the temperature is above the clearing point of the compound used in higher concentration, the completion of the dissolution process is particularly easy to observe. However, it is also possible to prepare the media in other conventional ways, for example using so-called premixes, which may be, for example, homologous or eutectic mixtures of compounds, or using so-called “multibottle” systems, whose constituents are themselves ready-to-use mixtures.

In the present application, unless expressly indicated otherwise, the plural form of a term denotes both the singular form and also the plural form, and vice versa.

Further combinations of the embodiments and variants of the invention in accordance with the description also arise from the claims.

### FURTHER ABBREVIATIONS

THF tetrahydrofuran
MTBE methyl tert-butyl ether
SiO₂ silica gel for chromatography

The following examples explain the present invention without restricting it in any way.

However, the physical properties make it clear to the person skilled in the art what properties can be achieved and in what ranges they can be modified. In particular, the combination of the various properties which can preferably be achieved is thus well defined for the person skilled in the art.

### EXAMPLES

### Example 1

### 2-{4-[Difluoro-(2,3′,5′-trifluoro-4′-trifluoromethylbiphenyl-4-yloxy)methyl]-3,5-difluorophenyl}-5-propyltetrahydropyran (“AUQGU-3-T”)

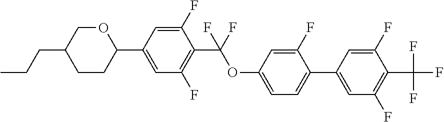 [SMILES: CCCC1CCC(c2cc(F)c(C(F)(F)Oc3ccc(-c4cc(F)c(C(F)(F)F)c(F)c4)c(F)c3)c(F)c2)OC1]

The compound according to the invention is prepared as described below:

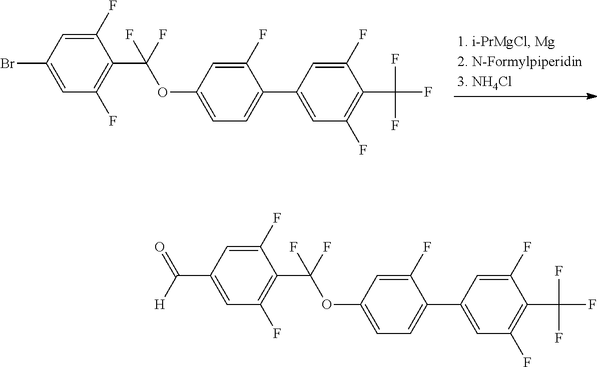 [SMILES: Fc1cc(OC(F)(F)c2c(F)cc(Br)cc2F)ccc1-c1cc(F)c(C(F)(F)F)c(F)c1 ; O=Cc1cc(F)c(C(F)(F)Oc2ccc(-c3cc(F)c(C(F)(F)F)c(F)c3)c(F)c2)c(F)c1]

100 mg (4 mmol) of magnesium turnings are initially introduced in 150 ml of THF, and 30.0 ml (60.0 mmol) of i-PrMgCl (2 M soln. in THF) are added. After 30 min, a solution of 22.0 g (41.3 mmol) of 4′-[(4-bromo-2,6-difluorophenyl)difluoromethoxy]-3,5,2′-trifluoro-4-trifluoromethylbiphenyl in 100 ml of THF is added dropwise. When the addition is complete, the mixture is stirred at room temperature for 2 h. 7.0 ml (63.1 mmol) of N-formylpiperidine in 50 ml of THF are added, and the mixture is stirred for 19 h. Saturated ammonium chloride solution is added to the batch, which is then extracted a number of times with MTBE. The combined organic phases are washed with saturated sodium chloride solution, and the solution is dried using sodium sulfate. The crude product remaining after removal of the solvents is purified by column chromatography (SiO₂, n-heptane:toluene=1:1), giving 4-[difluoro-(2,3′,5′-trifluoro-4′-trifluoromethylbiphenyl-4-yloxy)methyl]-3,5-difluorobenzaldehyde as a yellowish solid.

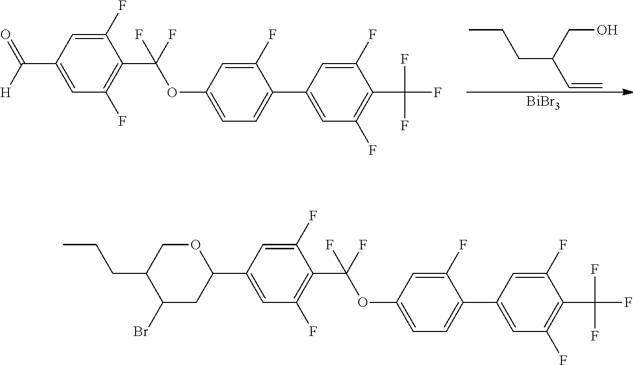

9.0 g (18.5 mmol) of 4-[difluoro-(2,3′,5′-trifluoro-4′-trifluoromethylbiphenyl-4-yloxy)methyl]-3,5-difluorobenzaldehyde are initially introduced in 120 ml of dichloromethane together with 2.20 g (19.3 mmol) of 2-vinylpentan-1-ol, and 4.40 g (9.61 mmol) of bismuth(III) bromide are added in portions. The batch is stirred for 22 h, and the mixture is filtered absorptively (SiO₂, dichloromethane). The filtrate is concentrated to dryness, and the crude product is purified by column chromatography (SiO₂, n-heptane:toluene=1:1), giving 4-bromo-2-{4-[difluoro-(2,3′,5′-trifluoro-4′-trifluoromethylbiphenyl-4-yloxy)methyl]-3,5-difluorophenyl}-5-propyltetrahydropyran as a colourless solid. The mixture of two stereoisomers is used for the next reaction.

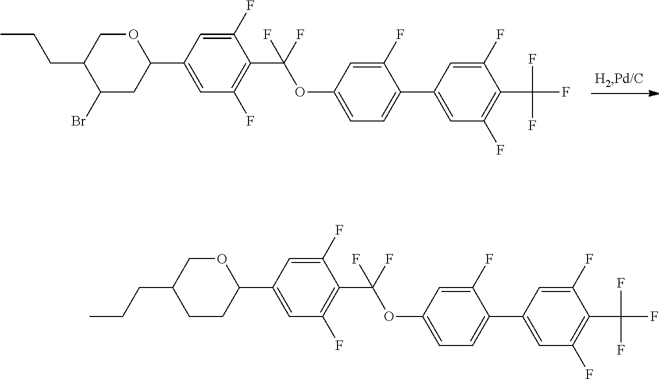 [SMILES: CCCC1COC(c2cc(F)c(C(F)(F)Oc3ccc(-c4cc(F)c(C(F)(F)F)c(F)c4)c(F)c3)c(F)c2)CC1Br ; CCCC1CCC(c2cc(F)c(C(F)(F)Oc3ccc(-c4cc(F)c(C(F)(F)F)c(F)c4)c(F)c3)c(F)c2)OC1]

10.0 g (14.7 mmol) of 4-bromo-2-{4-[difluoro-(2,3′,5′-trifluoro-4′-trifluoromethylbiphenyl-4-yloxy)methyl]-3,5-difluorophenyl}-5-propyltetrahydropyran are dissolved in THF, and the mixture is hydrogenated for 50 h at a hydrogen pressure of 5.8 bar and at 50° C. in the presence of triethylamine and Pd/C. The solution is filtered and concentrated to dryness. The crude product is purified by column chromatography (SiO₂, n-heptane:toluene=1:1). The further purification is carried out by recrystallisation from isopropanol, giving trans-2-{4-[difluoro-(2,3′,5′-trifluoro-4′-trifluoromethylbiphenyl-4-yloxy)methyl]-3,5-difluorophenyl}-5-propyltetrahydropyran (“AUQGU-3-T”) as a colourless solid having a melting point of 95° C.

### C 95 N (81) I

Δ∈=37
Δn=0.131
γ₁=752 mPa·s
Δ∈·Δn=4.9

¹H-NMR (300 MHz, CHCl₃): δ=7.44-7.36 (m, 1H, H_{arom.}), 7.23-7.12 (m, 4H, H_{arom.}), 6.99 (d, 2H, J=10.8 Hz, Hₐᵣₒₘ), 4.26 (dd, 1H, J=11.3 Hz, J=1.8 Hz, H_{pyranyl.}), 4.09 (ddd, 1H, J=11.3 Hz, J=4.5 Hz, J=1.8 Hz, H_{pyranyl.}), 3.19 (t, 1H, J=11.3 Hz, H_{pyranyl.}), 2.05-1.96 (m, 1H, H_{aliph.}), 1.93-1.85 (m, 1H, H_{aliph.}), 1.73-1.58 (m, 1H, H_{aliph.}), 1.55-1.07 (m, 6H, H_{arom.}), 0.92 (t, 3H, J=7.4 Hz, —CH₂CH₂CH₃).

¹⁹F-NMR (282 MHz, CHCl₃): δ=−56.3 (t, 3F, J=21.9 Hz, —CF₃), −60.9 (t, 2F, J=25.6 Hz, —OCF₂—), −110.5 to −110.7 (m, 4F, F_{arom.}), −113.6 (s, 1F, F_{arom.}).

MS (EI): m/e (%)=580 (3, M⁺), 561 (3, [M−F]⁺), 289 (100).

### Example 2

### 2-{4-[Difluoro-(2,3′,5′-trifluoro-4′-trifluoromethoxybiphenyl-4-yloxy)methyl]-3,5-difluorophenyl}-5-propyl-1,3-dioxane (“DUQGU-3-OT”)

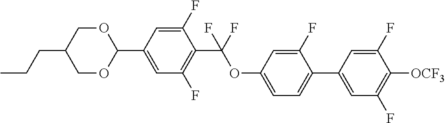 [SMILES: CCCC1COC(c2cc(F)c(C(F)(F)Oc3ccc(-c4cc(F)c(OC(F)(F)F)c(F)c4)c(F)c3)c(F)c2)OC1]

The compound according to the invention is prepared as described below:

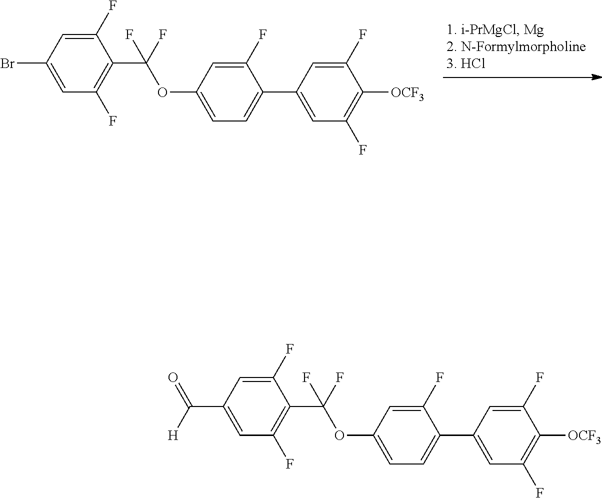 [SMILES: Fc1cc(OC(F)(F)c2c(F)cc(Br)cc2F)ccc1-c1cc(F)c(OC(F)(F)F)c(F)c1 ; O=Cc1cc(F)c(C(F)(F)Oc2ccc(-c3cc(F)c(OC(F)(F)F)c(F)c3)c(F)c2)c(F)c1]

90 mg (3.7 mmol) of magnesium turnings are initially introduced in 200 ml of THF, and 26.0 ml (52.0 mmol) of i-PrMgCl (2M soln. in THF) are added. After 30 min, a solution of 19.0 g (34.6 mmol) of 4′-[(4-bromo-2,6-difluorophenyl)difluoromethoxy]-3,5,2′-trifluoro-4-trifluoromethoxybiphenyl in 50 ml of THF is added dropwise. When the addition is complete, the mixture is stirred at room temperature for 4 h. 5.8 ml (52.3 mmol) of N-formylpiperidine in 30 ml of THF are added, and the mixture is stirred for 21 h. Dil. hydrochloric acid is added to the batch, which is then extracted a number of times with MTBE. The combined organic phases are washed with saturated sodium hydrogencarbonate solution, and the solution is dried using sodium sulfate. The crude product remaining after removal of the solvents is purified by column chromatography (SiO₂, n-heptane:toluene=1:1), giving 4-[difluoro-(2,3′,5′-trifluoro-4′-trifluoromethoxybiphenyl-4-yloxy)methyl]-3,5-difluorobenzaldehyde as a yellowish solid.

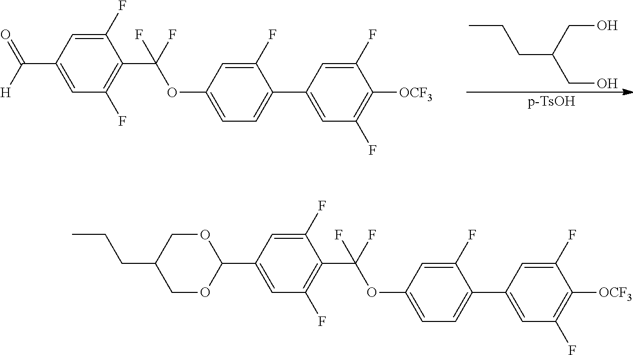

3.50 g (7.02 mmol) of 4-[difluoro-(2,3′,5′-trifluoro-4′-trifluoromethoxybiphenyl-4-yloxy)methyl]-3,5-difluorobenzaldehyde are refluxed for 3 h on a water separator in 100 ml of toluene together with 850 mg of 2-n-propylpropane-1,3-diol and 30 mg of p-toluenesulfonic acid monohydrate. After cooling, the batch is washed with water and saturated sodium hydrogencarbonate solution. The solution is dried using sodium sulfate and concentrated to dryness. The crude product is purified by column chromatography (SiO₂, toluene). The further purification is carried out by recrystallisation from ethanol and n-heptane, giving 2-{4-[difluoro-(2,3′,5′-trifluoro-4′-trifluoromethoxybiphenyl-4-yloxy)methyl]-3,5-difluorophenyl}-5-propyl-1,3-dioxane as a colourless solid having a melting point of 61° C.

### C 61 N 93 I

Δ∈=36
Δn=0.129
γ₁=634 mPa·s
Δ∈·Δn=4.7

¹H-NMR (300 MHz, CHCl₃): δ=7.40-7.33 (m, 1H, H_{arom.}), 7.23-7.11 (m, 6H, H_{arom.}), 5.37 (s, 1H, H_{dioxanyl.}), 4.24 (ddd, 2H, J=11.0 Hz, J=4.6 Hz, J=1.5 Hz, H_{dioxanyl.}), 3.52 (dt, 2, H, J=10.8 Hz, J=1.5 Hz, H_{dioxanyl.}), 2.20-2.05 (m, 1H, H_{aliphat.}), 1.41-1.27 (m, 2H, H_{aliphat.}), 1.14-1.04 (m, 2H, H_{aliphat.}), 0.98 (t, 3H, J=7.3 Hz, —CH₂CH₂CH₃).

¹⁹F-NMR (282 MHz, CHCl₃): δ=−59.7 (t, 3F, J=7.3 Hz, —OCF₃), −60.9 (t, 2F, J=26.8 Hz, —OCF₂—), −110.0 (dt, 2F, J=26.8 Hz, J=9.2 Hz, F_{arom.}), −114.0 (t, 1F, J=9.2 Hz, F_{arom.}), −124.5 to −124.6 (m, 2F, F_{arom.}).

MS (EI): m/e (%)=598 (12, M⁺), 579 (2, [M−F]⁺), 291 (100).

Example compounds 3 to 5 are prepared analogously to Example 1. The spectroscopic data (NMR, MS) in each case correspond to the structures.

| | | |
|---|---|---|
| 3 | 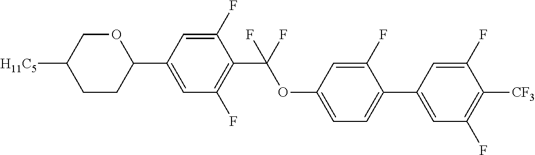 “AUQGU-5-T” | C 74 SmA (39) N 89 I Δε = 38 Δn = 0.130 γ₁ = 1194 mPa•s Δε • Δn = 5.0 |
| 4 | 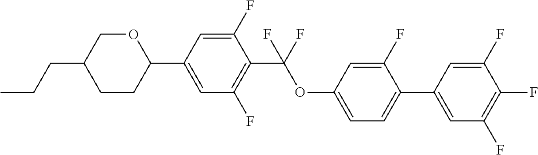 [SMILES: CCCC1CCC(c2cc(F)c(C(F)(F)Oc3ccc(-c4cc(F)c(F)c(F)c4)c(F)c3)c(F)c2)OC1] “AUQGU-3-F” | Tg −42 C 49 N 82 I Δε = 27 Δn = 0.129 γ₁ = 459 mPa•s Δε • Δn = 3.5 |
| 5 | 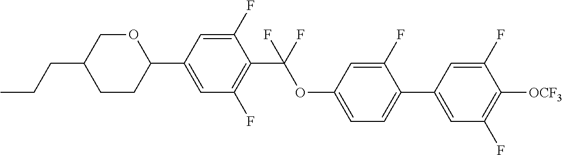 [SMILES: CCCC1CCC(c2cc(F)c(C(F)(F)Oc3ccc(-c4cc(F)c(OC(F)(F)F)c(F)c4)c(F)c3)c(F)c2)OC1] “AUQGU-3-OT” | Tg −46 C 61 SmA (12) N 102 I Δε = 30 Δn = 0.125 γ₁ = 615 mPa•s Δε • Δn = 3.8 |

Example compounds 6 and 7 are prepared analogously to Example 2. The spectroscopic data (NMR, MS) in each case correspond to the structures.

| | | |
|---|---|---|
| 6 | 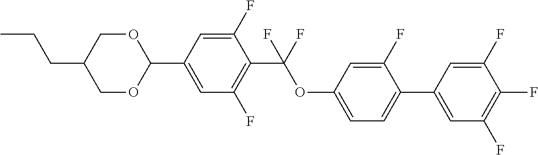 [SMILES: CCCC1COC(c2cc(F)c(C(F)(F)Oc3ccc(-c4cc(F)c(F)c(F)c4)c(F)c3)c(F)c2)OC1] “DUQGU-3-F” | C 61 N 79 I Δε = 35 Δn = 0.129 γ₁ = 436 Δε • Δn = 4.5 |
| 7 | 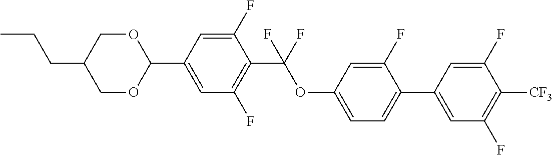 [SMILES: CCCC1COC(c2cc(F)c(C(F)(F)Oc3ccc(-c4cc(F)c(C(F)(F)F)c(F)c4)c(F)c3)c(F)c2)OC1] “DUQGU-3-T” | C 96 I Δε = 40 Δn = 0.1314 γ₁ = 744 Δε • Δn = 5.3 |

### Mixture Examples

The following acronyms are used to describe the components of the liquid-crystalline base mixture (host). The index n adopts a value of 1 to 9. The compounds are suitable for the preparation of liquid-crystalline media according to the invention.

TABLE A
Further acronyms for LC components

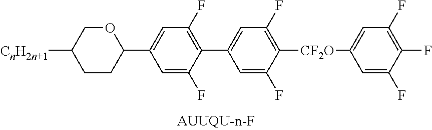

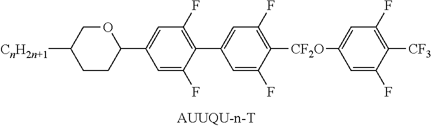

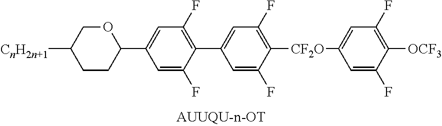

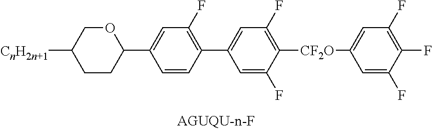

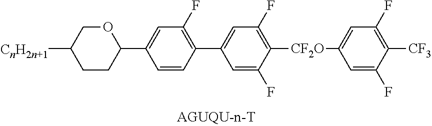

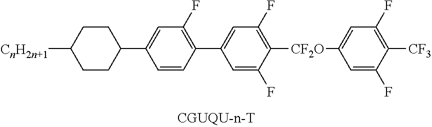

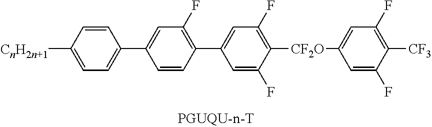

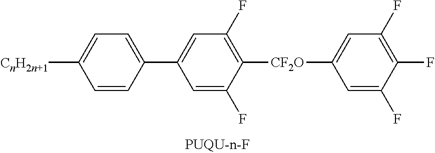

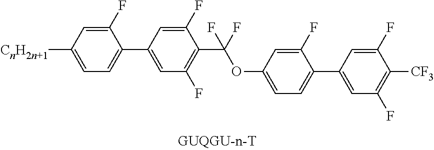

The following monomers are preferably used:

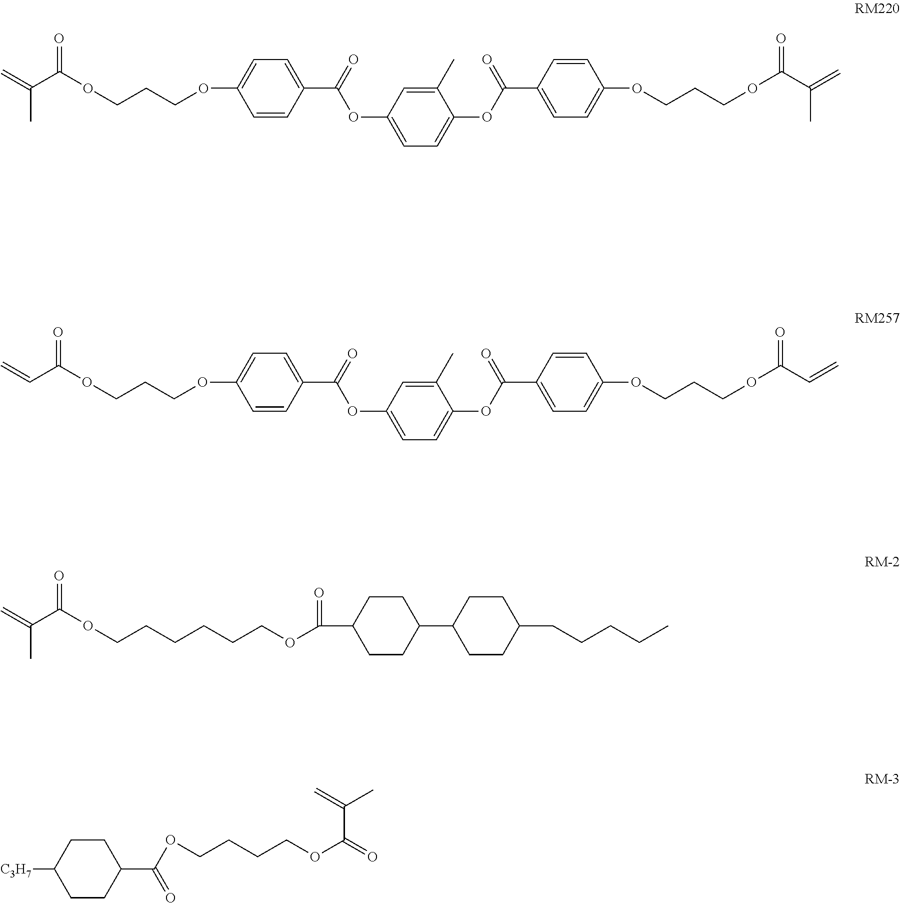

RM220 has the phase sequence C 82.5 N 97 I.
RM257 has the phase sequence C 66 N 127 I.

The following additives are preferably used

(DP: chiral dopant, IN: polymerisation initiator):

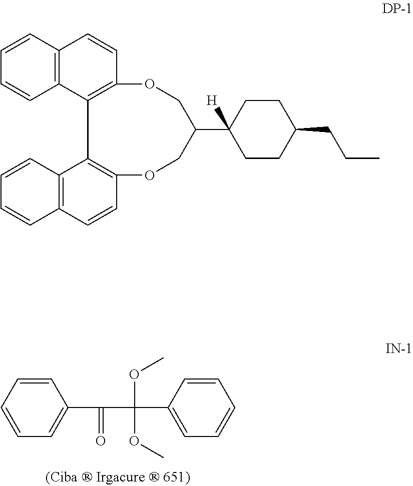 [SMILES: CCC[C@H]1CC[C@H](C2COc3ccc4ccccc4c3-c3c(ccc4ccccc34)OC2)CC1 ; COC(OC)(C(=O)c1ccccc1)c1ccccc1]

Further chiral dopants and polymerisation initiators for LC mixtures are known to the person skilled in the art and are expressly mentioned here.

The media are characterised as described before the polymerisation. The RM components are then polymerised by irradiation once (180 s) in the blue phase, and the media obtained are re-characterised.

### Description of the Polymerisation

Before the polymerisation of a sample, the phase properties of the medium are established in a test cell having a thickness of about 10 microns and an area of 2×2.5 cm. The filling is carried out by capillary action at a temperature of 75° C. The unpolymerised medium is measured under a polarising microscope with heating stage at a heating rate of 1° C./min. The polymerisation of the media is carried out by irradiation using a UV lamp (Höonle, Bluepoint 2.1, 365 nm interference filter) having an effective power of about 1.5 mW/cm² for 180 seconds. The polymerisation is carried out directly in the electro-optical test cell. The polymerisation is carried out initially at a temperature at which the medium is in blue phase I (BP-I). The polymerisation is carried out in a plurality of part-steps which little by little result in complete polymerisation. The temperature range of the blue phase generally changes during the polymerisation. The temperature is therefore adapted between each part-step in such a way that the medium is still in the blue phase. In practice, this can be carried out by observing the sample under the polarising microscope after each irradiation operation of about 5 s or longer. If the sample becomes darker, this indicates a transition into the isotropic phase. The temperature for the next part-step is reduced correspondingly. The entire irradiation time which results in maximum stabilisation is typically 180 s at the irradiation power indicated. Further polymerisations can be carried out in accordance with an optimised irradiation/temperature programme. Alternatively, the polymerisation can also be carried out in a single irradiation step, in particular if a sufficiently broad blue phase is already present before the polymerisation.

### Electro-Optical Characterisation

After the above-described polymerisation and stabilisation of the blue phase, the phase width of the blue phase is determined. The electro-optical characterisation is subsequently carried out at various temperatures within and, if desired, also outside this range.

The test cells used are fitted on one side with interdigital electrodes on the cell surface. The cell gap, the electrode separation and the electrode width are typically each 1 to 10 microns and are preferably of the same size. This uniform dimension is referred to below as the gap width. The area covered by electrodes is about 0.4 cm². The test cells do not have an alignment layer. For the electro-optical characterisation, the cell is located between crossed polarising filters, where the longitudinal direction of the electrodes adopts an angle of 45° to the axes of the polarising filter. The measurement is carried out using a DMS301 (Autronic-Melchers) at right angles to the cell plane or by means of a highly sensitive camera on the polarising microscope. In the voltage-free state, the arrangement described gives an essentially dark image (definition 0% transmission).

Firstly, the characteristic operating voltages and then the response times are measured on the test cell. The operating voltage at the cell electrodes is applied in the form of a rectangular voltage with alternating sign (frequency 100 Hz) and variable amplitude, as described below.

The transmission in the voltage-free state is defined as 0%. The transmission is measured while the operating voltage is increased. The achievement of the maximum value of about 100% intensity defines the characteristic quantity of the operating voltage, V₁₀₀. Equally, the characteristic voltage V₁₀ at 10% of maximum transmission is determined. These values are optionally measured at various temperatures in the region of the blue phase, in any case at room temperature (20° C.).

At the lower end of the temperature range of the blue phase, relatively high characteristic operating voltages V₁₀₀ are observed. At the upper end of the temperature range (close to the clearing point), the value of V₁₀₀ increases considerably. In the region of the minimum operating voltage, V₁₀₀ generally only increases slowly with the temperature. This temperature range, limited by T₁ and T₂, is known as the usable, flat temperature range (FR). The width of this ‘flat range’ (FR) is (T₂-T₁) and is known as the width of the flat range (WFR). The precise values of T₁ and T₂ are determined by the intersections of tangents at the flat curve section FR and the adjacent steep curve sections in the V₁₀₀/temperature diagram.

In the second part of the measurement, the response times are determined during switching on and off (τₒₙ, τ_{off}). The response time τₒₙ is defined by the time taken to achieve 90% intensity after application of a voltage at the level of V₁₀₀ at the selected temperature. The response time τ_{off} is defined by the time taken to decrease by 90% starting from maximum intensity at V₁₀₀ after reduction of the voltage to 0 V. The response time is also determined at various temperatures in the region of the blue phase.

As further characterisation, the transmission can be measured at a temperature within the FR with a continuously varied operating voltage between 0 V and V₁₀₀. On comparison of the curves for increasing and for decreasing operating voltage, hysteresis may occur. The difference in the transmissions at 0.5·V₁₀₀ and the difference in the voltages at 50% transmission are, for example, characteristic hysteresis values and are known as ΔT₅₀ and ΔV₅₀ respectively.

As a further characteristic quantity, the ratio of the transmission in the voltage-free state before and after passing through a switching cycle can be measured. This transmission ratio is known as the “memory effect”. The value of the memory effect in the ideal state is 1.0. Values above 1 mean that a certain memory effect is present in the form of excessive residual transmission after the cell has been switched on and off. This value is also determined in the working range of the blue phase (FR).

The measurement values, unless indicated otherwise, are determined at 20° C.

### Mixture Examples

### Mixture Example 1 (Host Mixture)

| Component | % by weight |
|---|---|
| AUUQU-2-F | 10 |
| AUUQU-3-F | 8 |
| AUUQU-5-F | 6 |
| AUUQU-3-T | 8 |
| AUQGU-3-F | 8 |
| PUZU-2-F | 5 |
| PUZU-3-F | 5 |
| PUZU-5-F | 5 |
| AGUQU-3-F | 4 |
| AUUQU-3-N | 5 |
| GUQGU-2-T | 9 |
| GUQGU-3-T | 9 |
| GUQGU-4-T | 9 |
| GUQGU-5-T | 9 |

Clearing point: 76° C.

### Mixture Example 2 (Host Mixture)

| Component | % by weight |
|---|---|
| AUUQU-2-F | 10 |
| AUUQU-3-F | 8 |
| AUUQU-5-F | 6 |
| AUUQU-3-T | 8 |
| AUQGU-3-OT | 8 |
| PUZU-2-F | 5 |
| PUZU-3-F | 5 |
| PUZU-5-F | 5 |
| AGUQU-3-F | 4 |
| AUUQU-3-N | 5 |
| GUQGU-2-T | 9 |
| GUQGU-3-T | 9 |
| GUQGU-4-T | 9 |
| GUQGU-5-T | 9 |

### Mixture Example 3 (Host Mixture)

| Component | % by weight |
|---|---|
| AUUQU-2-F | 10 |
| AUUQU-3-F | 8 |
| AUUQU-5-F | 6 |
| AUUQU-3-T | 8 |
| AUQGU-3-T | 8 |
| PUZU-2-F | 5 |
| PUZU-3-F | 5 |
| PUZU-5-F | 5 |
| AGUQU-3-F | 4 |
| AUUQU-3-N | 5 |
| GUQGU-2-T | 9 |
| GUQGU-3-T | 9 |
| GUQGU-4-T | 9 |
| GUQGU-5-T | 9 |

### Mixture Example 4 (Host Mixture)

| Component | % by weight |
|---|---|
| AUUQU-2-F | 10 |
| AUUQU-3-F | 8 |
| AUUQU-5-F | 6 |
| AUUQU-3-T | 8 |
| DUQGU-3-F | 8 |
| PUZU-2-F | 5 |
| PUZU-3-F | 5 |
| PUZU-5-F | 5 |
| AGUQU-3-F | 4 |
| AUUQU-3-N | 5 |
| GUQGU-2-T | 9 |
| GUQGU-3-T | 9 |
| GUQGU-4-T | 9 |
| GUQGU-5-T | 9 |

### Mixture Example 5 (Host Mixture)

| Component | % by weight |
|---|---|
| AUUQU-2-F | 10 |
| AUUQU-3-F | 8 |
| AUUQU-5-F | 6 |
| AUUQU-3-T | 8 |
| DUQGU-3-OT | 8 |
| PUZU-2-F | 5 |
| PUZU-3-F | 5 |
| PUZU-5-F | 5 |
| AGUQU-3-F | 4 |
| AUUQU-3-N | 5 |
| GUQGU-2-T | 9 |
| GUQGU-3-T | 9 |
| GUQGU-4-T | 9 |
| GUQGU-5-T | 9 |

### Mixture Example 6 (Host Mixture)

| Component | % by weight |
|---|---|
| AUUQU-2-F | 10 |
| AUUQU-3-F | 8 |
| AUUQU-5-F | 6 |
| AUUQU-3-T | 8 |
| DUQGU-3-T | 8 |
| PUZU-2-F | 5 |
| PUZU-3-F | 5 |
| PUZU-5-F | 5 |
| AGUQU-3-F | 4 |
| AUUQU-3-N | 5 |
| GUQGU-2-T | 9 |
| GUQGU-3-T | 9 |
| GUQGU-4-T | 9 |
| GUQGU-5-T | 9 |

### Mixture Example 7

A typical polymer-stabilisable mixture has the composition as shown in the table:

| Component | % by weight |
|---|---|
| Host mixture (1-6) | 85 |
| IN-1 | 0.2 |
| Monoreactive mesogen | 5 |
| (RM-2/RM-3) | |
| Direactive mesogen | 6 |
| (RM220/RM257) | |
| Chiral dopant (DP-1) | 3.8 |

The polymerisable mixture is polymerised in a single irradiation step at a temperature of about 30-50° C. at the lower end of the temperature range of the blue phase (details cf. above).

The polymer-stabilised liquid-crystalline media exhibit a blue phase over a broad temperature range.

1. Compounds of the formula I 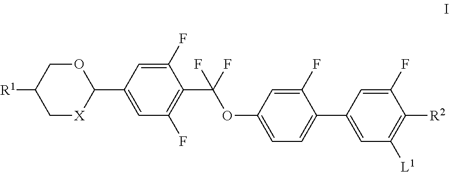
in which
L¹ denotes H or F,
X denotes O or CH₂,
R¹ denotes an unsubstituted alkyl radical having 1 to 15 C atoms, where, in addition, one or more CH₂ groups in this radical may each be replaced, independently of one another, by —C≡C—, —CH═CH—, —CF═CF—, —CF═CH—, —CH═CF—, —(CO)O—, —O(CO)—, —(CO)— or —O— in such a way that O atoms are not linked directly to one another,
and
R² denotes F, CF₃ or OCF₃.

2. Compounds according to claim 1, characterised in that L¹ denotes fluorine.

3. Compounds according to claim 1, characterised in that R² denotes a group CF₃.

4. Compounds according to claim 1, characterised in that
X denotes O.

5. Compounds according to claim 1, characterised in that
R¹ denotes an alkyl radical having 1 to 9 C atoms or an alkenyl radical having 2 to 9 C atoms.

6. Compounds according to claim 1, characterised in that
R¹ denotes a straight-chain alkyl radical having 3 C atoms.

7. Process for the preparation of compounds of the formula I according to claim 1, comprising a reaction step in which two starting materials of the formulae A and B: 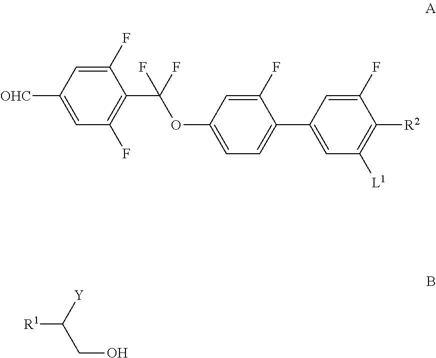
in which R¹, R² and L¹ are as defined for formula I, and
Y denotes a radical of the formula —CH═CH₂ or —CH₂—OH,
are reacted under suitable reaction conditions.

8. Liquid-crystalline medium, characterised in that it comprises one or more compounds of the formula I according to claim 1.

9. Liquid-crystalline medium according to claim 8, characterised in that it additionally comprises one or more compounds selected from the compounds of the formulae II and III: 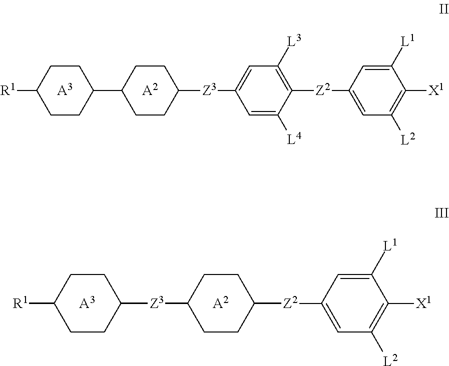
in which
R¹, independently of one another, denotes an unsubstituted alkyl radical having 1 to 15 C atoms, where, in addition, one or more CH₂ groups in this radical may each be replaced, independently of one another, by —CH═CH—, —CF═CF—, —CF═CH—, —CH═CF—, —(CO)O—, —O(CO)—, —(CO)— or —O— in such a way that O atoms are not linked directly to one another,
A², A³, independently of one another, denote 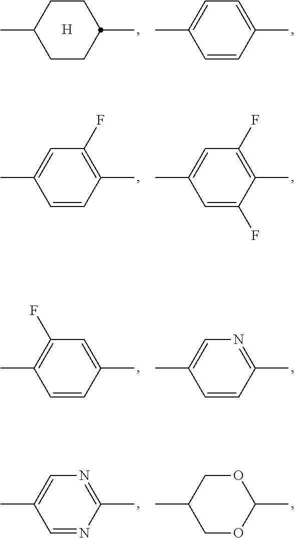
Z², Z³, independently of one another, denote a single bond, CF₂O, CH₂CH₂, CF₂CH₂, CF₂CF₂, CFHCFH, CFHCH₂, (CO)O, CH₂O, C≡C, CH═CH, CF═CH, CF═CF, where asymmetrical bonding units may be oriented in both possible directions,
X¹ denotes F, Cl, CN, or
alkyl, alkenyl, alkenyloxy, alkoxyalkyl or alkoxy having 1 to 3 C atoms, which is mono- or polysubstituted by F, and
L¹ to L⁴ denote H or F.

10. (canceled)

11. Electro-optical display device containing a liquid-crystalline medium according to claim 8.

12. Electro-optical display device according to claim 11, characterised in that it operates entirely or partly in the region of the liquid-crystalline blue phase.
